(19) United States
(12) Patent Application Publication
(10) Pub. No.: US 2014/0082946 A1
(43) Pub. Date: Mar. 27, 2014

(54) SCISSORS

(71) Applicants: Shinnosuke Kawai, Osaka (JP); Masanori Ando, Osaka (JP); Mitsuhiro Takasaki, Osaka (JP)

(72) Inventors: Shinnosuke Kawai, Osaka (JP); Masanori Ando, Osaka (JP); Mitsuhiro Takasaki, Osaka (JP)

(73) Assignee: ENGINEER INCORPORATION, Osaka-shi, Osaka (JP)

(21) Appl. No.: 14/112,738

(22) PCT Filed: Jun. 13, 2012
(86) PCT No.: PCT/JP2012/065095

§ 371 Date: Oct. 18, 2013

(30) Foreign Application Priority Data
Jun. 13, 2011 (JP) 2011-131037

(51) Int. Cl. B26B 13/20

(52) U.S. Cl. CPC B26B 13/20
USPC 30/233

(57) ABSTRACT

Provided are scissors with excellent safety that can more reliably prevent finger pinch when being closed. In the present invention, finger pinch prevention guards 20a, 20b for preventing fingertips from entering the opposing inner surfaces 10a, 10b side from above or below are formed on left and right operation portions 7a, 7b. This can prevent user's fingertips from reaching the opposing inner surfaces (10a, 10b) by setting the user's fingertips inserted into finger placing holes (6a, 6b) along upper and lower surfaces of the finger pinch prevention guards 20a, 20b. Consequently, when the operation portions 7a, 7b are in the closed position, the fingertips are prevented from being pinched between the opposing inner surfaces 10a, 10b so as not to cause finger pinch.

### TECHNICAL FIELD

The present invention relates to scissors, and particularly relates to a technique for preventing finger pinch.

### BACKGROUND ART

As a method for preventing finger pinch in the field of scissors, as described in Patent Document 1 for example, providing a protrusion on an opposing inner surface of an operation portion is publicly known. In Patent Document 1, a protrusion is provided on an inner surface of one operation portion opposite to the other operation portion so that the both operation portions are not abutted on a line or a surface, thereby preventing fingertips from being pinched between the both operation portions. A similar protrusion is also seen in Patent Document 2 relating to an earlier application of Patent Document 1. A similar protrusion is also seen in Japanese scissors and scissors for hairdressing.

### PRIOR ART DOCUMENTS

### Patent Documents

Patent Document 1: JP 2004-73310 A (paragraph 0022)
Patent Document 2: JP S52-099585 Y

### SUMMARY OF THE INVENTION

### Problem to be Solved by the Invention

As described above, in scissors in which a protrusion is used for restricting a closing operation limit of both operation portions so that the both operation portions are not abutted on a line or a surface, the protrusion abuts on the operation portion to form a gap between the both operation portions, and the presence of such a gap effectively prevents fingertips or the like from being pinched between the both operation portions. However, there still remains a fear that fingertips or the like are pinched between the protrusion and the opposing inner surface of the operation portion, and it is impossible to fundamentally prevent finger pinch. Such inconvenience is especially remarkable in scissors as a work tool which performs cutting a workpiece with great force, specifically scissors used for cutting metal plates, resin plates, ropes, or cables, and the like. That is, since great closing operation force is required to cut metal plates or the like, a user closes the operation portions with the fingertips entered deeply into finger placing holes of the operation portions. Accordingly, the fingertips which have passed through the finger placing holes easily reach the opposing inner surfaces of operation portions, and if the fingertip is placed on the protrusion, the fingertip is pinched between the protrusion and the opposing inner surface of the operation portion.

The present invention has been made to solve the above-described problem which conventional scissors have, and an object thereof is to provide scissors with excellent safety which can more reliably prevent finger pinch during closing operation.

### Means for Solving the Problem

As illustrated in FIG. 1, the scissors of the present invention includes: a pair of upper and lower scissor pieces 4a, 4b having cutting portions 2 at front ends thereof and handle portions 3 at rear ends thereof; a rotation center shaft 5 provided in center portions in front and rear directions of the scissor pieces 4a, 4b so as to crossingly and swingably support the scissor pieces 4a, 4b with each other, the scissor pieces 4a, 4b being assembled in an X-shape; and a pair of left and right operation portions 7a, 7b attached to the handle portions 3 of the scissor pieces 4a, 4b and having finger placing holes 6a, 6b for placing fingertips of a user, wherein, with the fingertips placed on the finger placing holes 6a, 6b, the cutting portions 2 are opened and closed by opening and closing the both operation portions 7a, 7b about the rotation center shaft 5 between an open position in which opposing inner surfaces 10a, 10b of the both operation portions 7a, 7b are apart from each other and a closed position in which the opposing inner surfaces 10a, 10b of the both operation portions 7a, 7b are close to each other.

Furthermore, finger pinch prevention guards 20a, 20b are formed on an upper end of one operation portion 7a on left or right and on a lower end of the other operation portion 7b so as to extend in a cantilever manner to an inside in left and right directions from the upper end and the lower end, thereby preventing the fingertips from entering the opposing inner surfaces 10a, 10b side from above or below by being overlapped with an upper end surface 16b or a lower end surface 16a of the operation portions 7b, 7a opposed thereto when the both operation portions 7b, 7a are in a closed position. An opposing gap is formed between the finger pinch prevention guards 20a, 20b and the upper end surface 16b and the lower end surface 16a of the operation portions 7b, 7a opposed to the finger pinch prevention guards 20a, 20b when the both operation portions 7a, 7b are in the closed position. Due to such an opposing gap, the finger pinch prevention guards 20a, 20b and the upper end surface 16b and the lower end surface 16a of the operation portions 7b, 7a opposed to these finger pinch prevention guards 20a, 20b do not make contact with each other when the both operation portions 7a, 7b are in the closed position.

As illustrated in FIGS. 4A and 4B, it is preferable to employ a mode in which the upper end surface 16b and the lower end surface 16a of the operation portions 7b, 7a opposed to the finger pinch prevention guards 20a, 20b in the closed position are flat surfaces.

As illustrated in FIG. 1 and the like, it is preferable to employ a mode in which anti-slipping recess and projection portions 25 are formed on base end portions of the operation portions 7a, 7b of the finger pinch prevention guards 20a, 20b.

Protruding portions 21a, 21b for restricting a proximity limit of the both operation portions 7a, 7b in the closed position are formed on one or both of the opposing inner surfaces 10a, 10b of the both operation portions 7a, 7b. An opposing gap 23 is formed between the both operation portions 7a, 7b in the closed position by the protruding portions 21a, 21b making contact with each other or by tip ends of the protruding portions 21a, 21b making contact with the opposing inner surfaces. The finger pinch prevention guards 20a, 20b are capable of preventing the fingertips from entering the opposing gap 23 by from above or below when the both operation portions 7a, 7b are in the closed position.

### Effects of the Invention

In the scissors according to the present invention, the finger pinch prevention guards 20a, 20b for preventing fingertips from entering the opposing inner surfaces 10a, 10b side from above or below are formed on both left and right operation portions 7a, 7b. More specifically, such finger pinch prevention guards 20a, 20b are formed on the upper end of one operation portion 7a on left or right and on the lower end of the other operation portion 7b so as to extend in a cantilever manner to the inside in the left and right directions from the upper end and the lower end. The finger pinch prevention guards 20a, 20b overlap with the upper end surface 16b or the lower end surface 16a of the operation portions 7b, 7a opposed thereto so as to prevent fingertips from entering the opposing inner surfaces 10a, 10b side from above or below when the operation portions 7a, 7b are in the closed position.

According to this configuration, fingertips placed on the finger placing holes 6a, 6b can be set along the finger pinch prevention guards 20a, 20b. That is, as shown in FIG. 8, when operating this type of scissors, a middle finger 33 and a third finger 34 are usually inserted into the finger placing hole 6a of one operation portion 7a, and a thumb 31 is inserted into the finger placing hole 6b of the other operation portion 7b. When the finger pinch prevention guards 20a, 20b are provided at the operation portions 7a, 7b as in the present invention, bending angles at the first joints of the middle finger 33 and the third finger 34 are restricted by the finger pinch prevention guards 20a, 20b, enabling fingertips of the middle finger 33 and the third finger 34 to be set along the upper and lower outer surface of the finger pinch prevention guards 20a, 20b. This can prevent fingertips of the middle finger 33 and the third finger 34 which are inserted deeply into the finger placing holes 6a, 6b from being bent substantially at right angles at the first joints and reaching the opposing inner surfaces 10a, 10b. Therefore, when the operation portions 7a, 7b are in the closed position, the fingertips of the middle finger 33 and the third finger 34 can be reliably prevented from being pinched between the opposing inner surfaces 10a, 10b of the operation portions 7a, 7b. Note that, the above middle finger 33 or the like is an example of a finger to be inserted into the finger placing hole 6a or the like, and the finger to be inserted into the finger placing hole 6a differs depending on the length and the size of fingers of a user.

Further, when the finger pinch prevention guards 20a, 20b are formed at the both operation portions 7a, 7b, finger pinch can be prevented even if the middle finger 33 and the third finger 34 are inserted into the finger placing holes 6a, 6b of either of the operation portions 7a, 7b, and scissors 1 with excellent usability can be obtained. Additionally, the scissors 1 shown in the embodiment of FIG. 1 and the like are right-handed scissors, and the arrangement position of the finger pinch prevention guards 20a, 20b is turned upside down in the case of left-handed scissors.

In the closed position, the upper end surface 16b and the lower end surface 16a of the operation portions 7b, 7a opposite to the finger pinch prevention guards 20a, 20b are preferably flat surfaces. This is because, if a recessed portion for receiving the finger pinch prevention guards 20a, 20b is formed in a recessed manner on the upper end surface 16b or the lower end surface 16a of the operation portions 7a, 7b, for example, fingertips may be pinched between the side surface which defines the recessed portion and the finger pinch prevention guards 20a, 20b. On the other hand, as in the present invention, when the upper end surface 16b and the lower end surface 16a of the operation portions 7b, 7a opposite to the finger pinch prevention guards 20a, 20b in the closed position are flat surfaces, such a problem that fingertips are pinched between the side surface which defines the recessed portion and the finger pinch prevention guards 20a, 20b as described above does not occur, and finger pinch can be prevented more reliably.

When the anti-slipping recess and projection portions 25 are formed on the base end portions of the operation portions 7a, 7b of the finger pinch prevention guards 20a, 20b, by placing fingertips of the middle finger 33 and the like on the recess and projection portions 25, the state of the middle finger 33 and the like being inserted into the finger placing holes 6a, 6b can be more reliably maintained. Consequently, the fingertips can be prevented from reaching the opposing inner surfaces 10a, 10b by a careless sliding movement of the middle finger 33 and the like and the fingertips can be prevented from being pinched between the opposing inner surfaces 10a, 10b or the protruding portions 21a, 21b.

The protruding portions 21a, 21b for restricting the proximity limit of the both operation portions 7a, 7b in the closed position are formed on one or both of the opposing inner surfaces 10a, 10b of the both operation portions 7a, 7b. The opposing gap 23 is formed between the both operation portions 7a, 7b in the closed position by the protruding portions 21a, 21b making contact with each other or by tip ends of the protruding portions 21a, 21b making contact with the opposing inner surfaces 10a, 10b. It is preferable that the finger pinch prevention guards 20a, 20b prevent the fingertips from entering into the opposing gap 23 from above or below when the both operation portions 7a, 7b are in the closed position. This can more reliably prevent finger pinch, because, even if the fingertips carelessly enter the opposing inner surfaces 10a, 10b side beyond the finger pinch prevention guards 20a, 20b, the presence of the opposing gap 23 formed between the opposing inner surfaces 10a, 10b can prevent the finger pinch between the opposing inner surfaces 10a, 10b.

### BRIEF DESCRIPTION OF THE DRAWINGS

FIG. 1 is a front view of scissors according to the present invention.

FIG. 2 is a side view of the scissors according to the present invention.

FIG. 3 is a front view of a main portion of the scissors according to the present invention.

FIGS. 4A and 4B are cross-sectional views taken along line A-A of FIG. 1.

FIG. 5 is a cross-sectional front view of the main portion of the scissors according to the present invention.

FIG. 6 is a cross-sectional view taken along line B-B of FIG. 1.

FIGS. 7A to 7D are a back view, a left-side view, a front view, and a right-side view of the scissors according to the present invention, respectively.

FIG. 8 is a view for describing a use of the scissors according to the present invention.

FIG. 9 is a view for describing another use of the scissors according to the present invention.

FIG. 10 is a view for describing still another use of the scissors according to the present invention.

### EMBODIMENTS OF THE INVENTION

### Embodiment

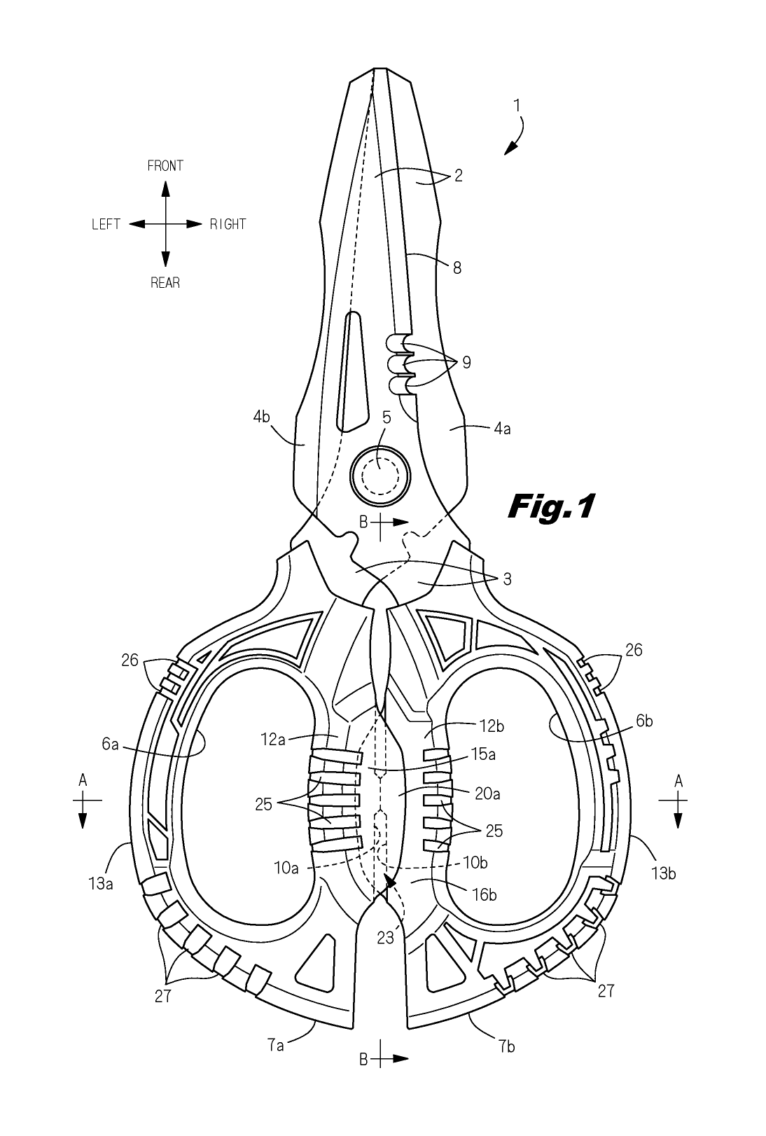

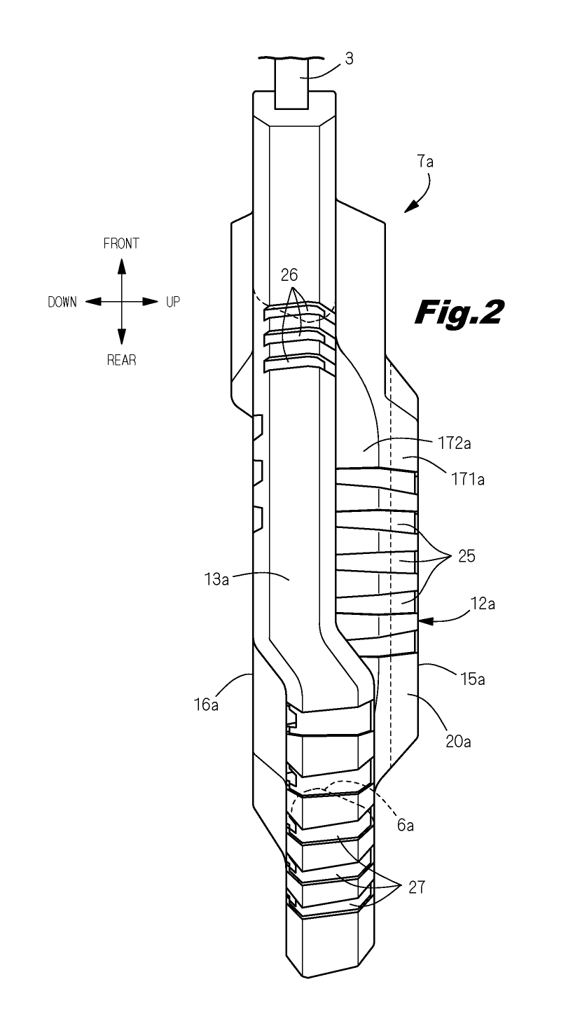

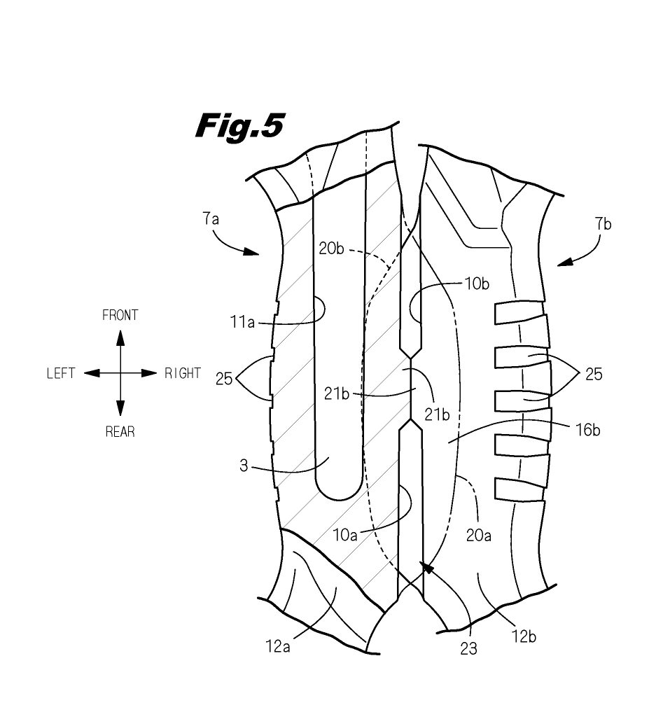

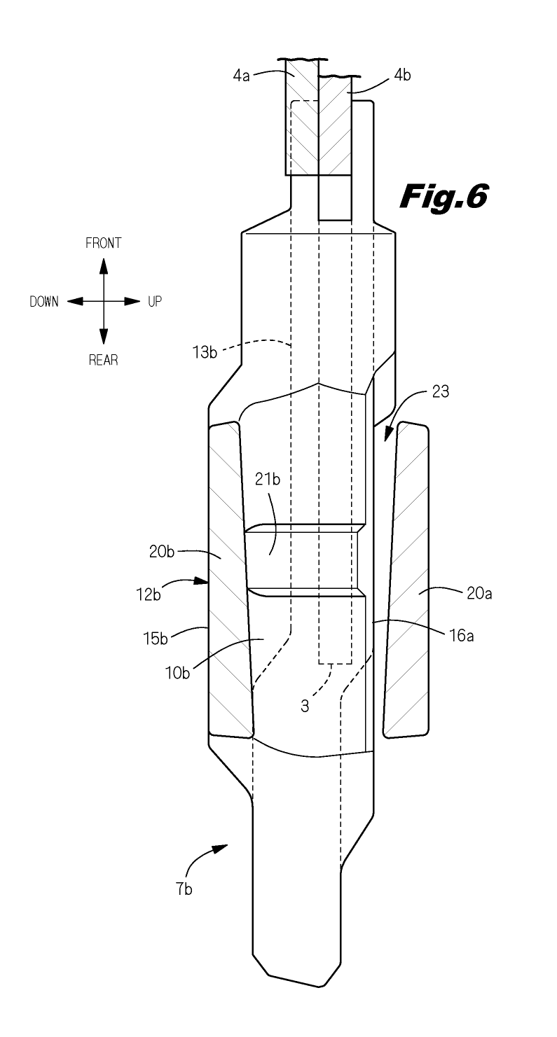

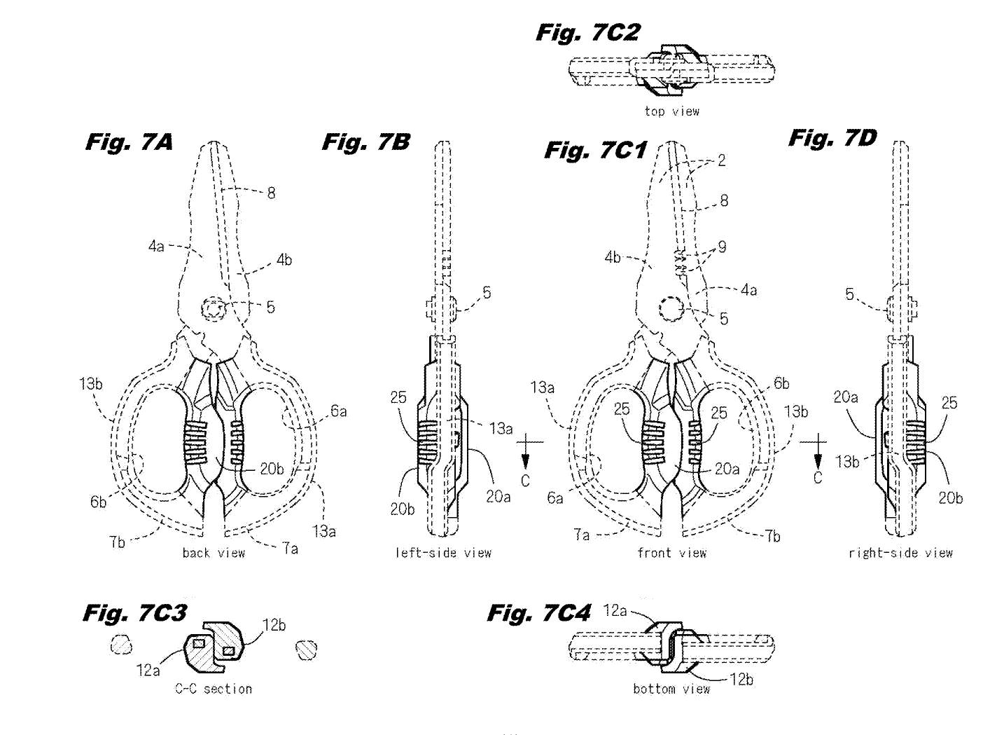

FIGS. 1 to 10 illustrate an embodiment in which the scissors according to the present invention is applied to scissors as a work tool used for cutting not only paper but also various workpieces such as metal plates, resin plates, ropes, and cables. Note that, front and rear, left and right, up and down in this embodiment correspond to the crossing arrows shown in FIGS. 1, 2, 5, and 6 and the indications of front and rear, left and right, up and down indicated near the respective arrows.

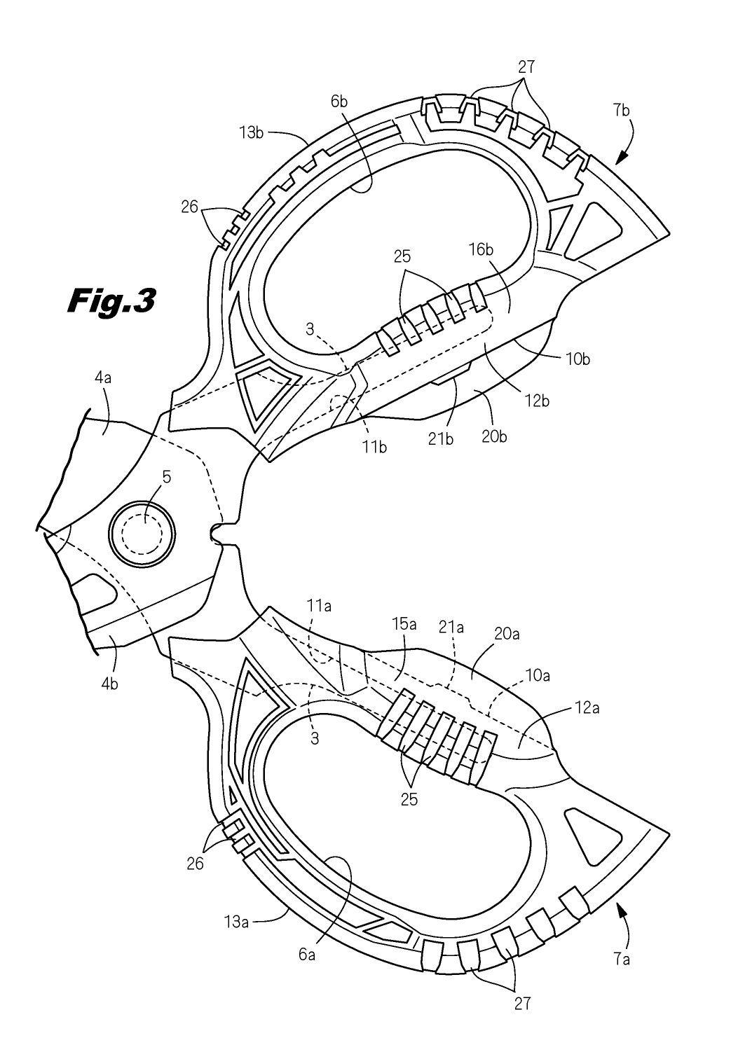

As illustrated in FIGS. 1 and 3, the scissors 1 include a pair of upper and lower scissor pieces 4b, 4a having cutting portions 2 at front ends thereof and handle portions 3 at rear ends thereof, a rotation center shaft 5 provided in center portions in the front and rear directions of the scissor pieces 4b, 4a so as to crossingly and swingably support the scissor pieces 4b, 4a with each other, the scissor pieces 4b, 4a being assembled in an X-shape, and a pair of left and right operation portions 7a, 7b which are attached to the handle portions 3 of the respective scissor pieces 4b, 4a and have finger placing holes 6a, 6b for placing fingertips of a user (refer to FIGS. 8 to 10). As illustrated in FIG. 1, the right operation portion 7b is attached to the handle portion 3 of the scissor piece 4b which is positioned on an upper side, and the left operation portion 7a is attached to the handle portion 3 of the scissor piece 4a which is positioned on a lower side.

The operation portions 7a, 7b are resin-made block bodies, and, with the fingertips placed on the both finger placing holes 6a, 6b, the both operation portions 7a, 7b are freely opened and closed about the rotation center shaft 5 between an open position (refer to FIG. 3) in which opposing inner surfaces 10a, 10b of the both operation portions 7a, 7b are apart from each other and a closed position (refer to FIG. 1) in which the opposing inner surfaces 10a, 10b of the both operation portions 7a, 7b are close to each other. As illustrated in FIG. 3, the cutting portions 2, 2 can be opened by making the both operation portions 7a, 7b in an open position, and as illustrated in FIG. 1, the cutting portions 2, 2 can be closed by making the both operation portions 7a, 7b in a closed position. Cutting work can thus be performed on the workpiece.

In FIG. 1, a reference sign 8 denotes cut surfaces provided to the cutting portions 2, 2 of the both scissor pieces 4b, 4a. On the rear end portion of the cut surface 8 of the upper scissor piece 4b, three cutting edges 9 in total for cutting outer coating films and the like of power cables are concavely formed.

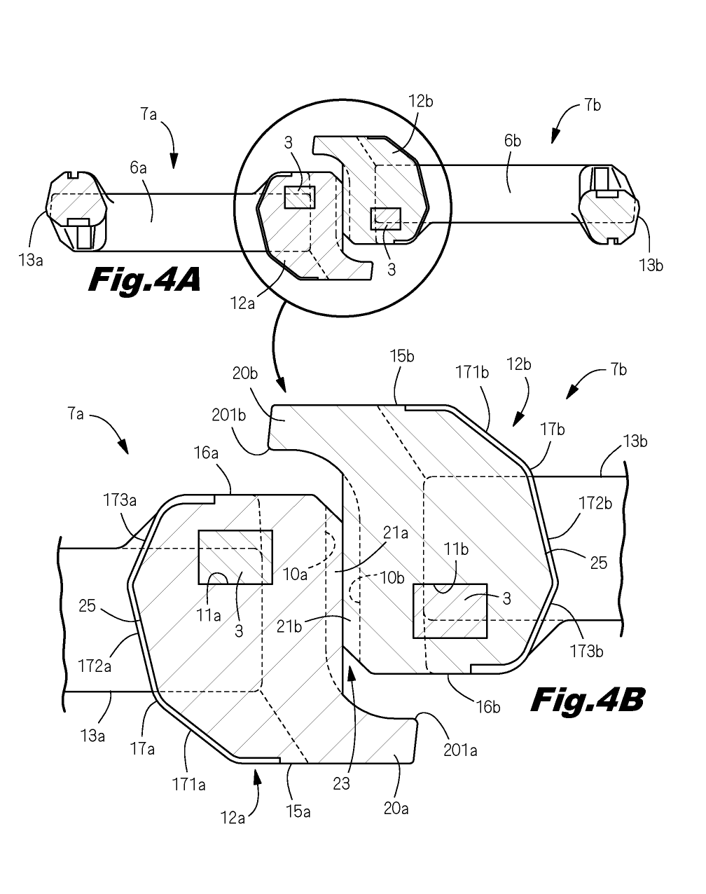

The left operation portion 7a includes a base block 12a having an attachment hole 11a to which the handle portion 3 is attached (refer to FIGS. 3, 4A and 4B), and an outer block 13a having a substantially semi-circular arc shape connected to the front and rear ends of the base block 12a. The left operation portion 7a is a resin-molded article formed in a ring shape in plan view by integrally molding the base block 12a and the outer block 13a. The right operation portion 7b is formed symmetrically to the left operation portion 7a, and includes a base block 12b having an attachment hole 11b to which the handle portion 3 is attached, and an outer block 13b having a substantially semi-circular arc shape connected to the front and rear ends of the base block 12b. The right operation portion 7b is a resin-molded article formed in a ring shape in plan view by integrally molding the base block 12b and the outer block 13b. In the center portions of the left and right operation portions 7a, 7b, the finger placing holes 6a, 6b are formed in a long oval shape in the front and rear directions. The inner peripheral edges of the finger placing holes 6a, 6b are defined by these base blocks 12a, 12b and outer blocks 13a, 13b.

As illustrated in FIGS. 4A and 4B, the base block 12a of the left operation portion 7a is formed in a cross-sectional polygonal shape having an upper end surface 15a, a lower end surface 16a, the opposing inner surface 10a positioned on the right, and a left side surface 17a positioned on the left. At the upper end of the base block 12a, a finger pinch prevention guard 20a is formed so as to extend in a cantilever manner to the inside in the left and right directions. The base block 12b of the right operation portion 7b formed symmetrically to the left operation portion 7a has a similar shape, and is formed in a cross-sectional polygonal shape having a lower end surface 15b, an upper end surface 16b, the opposing inner surface 10b positioned on the left, and a right side surface 17b positioned on the right. At the lower end of the base block 12b, a finger pinch prevention guard 20b is formed so as to extend in a cantilever manner to the inside in the left and right directions.

As illustrated in FIGS. 4A and 4B, the left side surface 17a of the operation portion 7a includes a first inclined surface 171a which inclines downward to the left continuously to the upper end surface 15a, a second inclined surface 172a which inclines downward to the left continuously to the first inclined surface 171a at a larger inclination angle than that of the first inclined surface 171a, and a third inclined surface 173a which inclines downward to the right continuously to the second inclined surface 172a. Similarly, the right side surface 17b of the operation portion 7b includes a first inclined surface 171b which inclines upward to the right continuously from the lower end surface 15b, a second inclined surface 172b which inclines upward to the right continuously to the first inclined surface 171b at a larger inclination angle than that of the first inclined surface 171b, and a third inclined surface 173b which inclines upward to the left continuously to the second inclined surface 172b.

As illustrated in FIGS. 4A, 4B and 5, the opposing inner surfaces 10a, 10b of the base blocks 12a, 12b of each operation portion 7a, 7b are formed of vertical surfaces extending in the vertical direction. In the center portions of the both opposing inner surfaces 10a, 10b in the front and rear directions, there are formed protruding portions 21a, 21b for defining the proximity limit of the both operation portions 7a, 7b in the closed position. As a result, as illustrated in FIG. 5, in the closed position in which the protruding surfaces of the both protruding portions 21a, 21b make contact with each other, an opposing gap 23 is formed between the opposing inner surfaces 10a, 10b of the both operation portions 7a, 7b except for a part where the protruding portions 21a, 21b are formed.

The above-mentioned finger pinch prevention guards 20a, 20b are provided for the purpose of preventing fingertips from entering the opposing gap 23 and being pinched between the opposing inner surfaces 10a, 10b. As described above, the finger pinch prevention guard 20a provided on the left operation portion 7a is formed so as to extend in a cantilever manner to the inside in the left and right directions from the upper end of the base block 12a. In the closed position, the finger pinch prevention guard 20a overlaps with the upper end surface 16b of the base block 12b of the right operation portion 7b with a predetermined space therebetween in the vertical direction, to prevent the fingertips from entering the opposing gap 23 from above (refer to FIGS. 4A and 4B). Similarly, the finger pinch prevention guard 20b provided on the right operation portion 7b is formed so as to extend in a cantilever manner to the inside in the left and right directions from the lower end of the base block 12b. In the closed position, the finger pinch prevention guard 20b overlaps with the lower end surface 16a of the base block 12a of the left operation portion 7a with a predetermined space therebetween in the vertical direction, to prevent the fingertips from entering the opposing gap 23 from below. The upper surface of the finger pinch prevention guard 20a is formed so as to be flush with the upper end surface 15a, and the lower surface of the finger pinch prevention guard 20b is formed so as to be flush with the lower end surface 15b.

More specifically, as illustrated in FIG. 8, usually, when a user uses the scissors 1 according to this embodiment, a middle finger 33 and a third finger 34 are inserted into the finger placing hole 6a of the left operation portion 7a, and a thumb 31 is inserted into the finger placing hole 6b of the right operation portion 7b. An index finger 32 and a little finger 35 are set along the outer circumferential edge of the outer block 13a of the operation portion 7a. Then, by operating a thumb 31 close to or away from the middle finger 33 and the third finger 34, the operation portions 7a, 7b are operated between the closed position and the open position to open and close the scissor pieces 4a, 4b. Accordingly, when the middle finger 33 and the third finger 34 inserted into the finger placing hole 6a are largely bent at the first joints to reach the opposing inner surface 10a (refer to FIG. 3), fingertips of the middle finger 33 and/or the third finger 34 may be pinched between the opposing inner surfaces 10a, 10b or between the protruding portions 21a, 21b to cause finger pinch when the operation portions 7a, 7b are in the closed position. Therefore, in the scissors 1 according to this embodiment, the finger pinch prevention guards 20a, 20b are formed so as to extend into the inside in the left and right directions on the base blocks 12a, 12b of the operation portions 7a, 7b, and the fingertips of the middle finger 33 and the third finger 34 are set along the surfaces of the finger pinch prevention guards 20a, 20b, whereby fingertips of the middle finger 33 and the third finger 34 are prevented from being pinched between the opposing inner surfaces 10a, 10b or between the protruding portions 21a, 21b. In other words, the finger pinch prevention guards 20a, 20b prevent the fingertips of the middle finger 33 and the third finger 34 from being largely bent at the first joints and reaching the opposing inner surfaces 10a, 10b, whereby the fingertips are prevented from being pinched between the opposing inner surfaces 10a, 10b or between the protruding portions 21a, 21b. Note that, since the thumb 31 as the first finger has fewer joints than other fingers such as the middle finger 33, the thumb 31 rarely reaches the opposing inner surfaces 10a, 10b and is unlikely to be pinched between the opposing inner surfaces 10a, 10b.

Further, in the scissors 1 according to this embodiment, the outer shapes of the left and right finger placing holes 6a, 6b are substantially the same. Thus, as shown in FIG. 8, it is possible to employ a mode in which the middle finger 33 and the third finger 34 are inserted into the left finger placing hole 6a to use the scissors 1, and to employ a mode in which the middle finger 33 and the third finger 34 are inserted into the right finger placing hole 6b to use the scissors 1. Therefore, when the finger pinch prevention guards 20a, 20b are provided to both of the left and right operation portions 7a, 7b as in this embodiment, finger pinch can be reliably prevented even if either of the above described modes for using the scissors 1 is employed. This means that finger pinch can be prevented even if a user inserts the middle finger 33 and the third finger 34 into either of the finger placing holes 6a, 6b of the left and right operation portions 7a, 7b. Thus, it is possible to provide the scissors 1 with excellent usability eliminating a difference of usage between the left and the right. On the other hand, in a mode in which the finger pinch prevention guard 20a, 20b is provided to only one of the left and right operation portions 7a, 7b, a user has to choose either of the finger placing holes 6a, 6b into which the middle finger 33 and the like should be inserted, thereby causing lowering of usability of the scissors 1.

Further, in the scissors 1 according to this embodiment, in addition to providing the finger pinch prevention guards 20a, 20b as described above, various measures for preventing finger pinch have been taken. Specifically, the upper and lower end surfaces 16a, 16b opposite to the finger pinch prevention guards 20a, 20b in the closed position are flat surfaces. That is, the upper end surface 16b of the base block 12b of the right operation portion 7b opposite to the finger pinch prevention guard 20a of the left operation portion 7a is a flat surface, and in addition, the lower end surface 16a of the base block 12a of the left operation portion 7a opposite to the finger pinch prevention guard 20b of the right operation portion 7b is a flat surface. In this way, when the upper and lower end surfaces 16a, 16b opposite to the finger pinch prevention guards 20a, 20b in the closed position are flat surfaces, the fingertips of the middle finger 33 and the like can be reliably prevented from being pinched between the upper and lower end surfaces 16a, 16b as the flat surfaces and the tip end portions of the finger pinch prevention guards 20a, 20b. That is, for example, when a recessed portion for receiving the finger pinch prevention guards 20a, 20b is formed on the upper and lower end surfaces 16a, 16b opposite to the finger pinch prevention guards 20a, 20b of the base blocks 12a, 12b in order to reduce the thickness of the base blocks 12a, 12b, the fingertips of the middle finger 33 and the like may be pinched between the side surface of such a recessed portion and the tip end portions of the finger pinch prevention guards 20a, 20b. On the other hand, when the upper and lower end surfaces 16a, 16b opposite to the finger pinch prevention guards 20a, 20b in the closed position are formed in flat surfaces as in this embodiment, even if the fingertips of the middle finger 33 and the like are placed on the upper and lower end surfaces 16a, 16b opposite to the finger pinch prevention guards 20a, 20b, the fingertips slide on the surfaces of the upper and lower end surfaces 16a, 16b in accordance with closing operation of the operation portions 7a, 7b. Therefore, a trouble that the fingertips of the middle finger 33 and the like are pinched between the upper and lower end surfaces 16a, 16b and the tip end portions of the finger pinch prevention guards 20a, 20b does not occur, and finger pinch can be reliably prevented.

Further, as illustrated in FIGS. 4A and 4B, in this embodiment, corner portions 201a, 201b opposite to the upper and lower end surfaces 16a, 16b of the tip end portions of the finger pinch prevention guards 20a, 20b are formed as curved surfaces. In this way, when the corner portions 201a, 201b opposite to the upper and lower end surfaces 16a, 16b of the tip end portions of the finger pinch prevention guards 20a, 20b are formed as the curved surfaces, the fingertips can be more reliably prevented from being hurt.

Further, in this embodiment, as illustrated in FIGS. 1, 3, and 8, anti-slipping recess and projection portions 25 are formed on contact points with the fingertips of the middle finger 33, the third finger 34, the thumb 31, and the like which are inserted into the finger placing holes 6a, 6b. Accordingly, by placing the fingertips of the middle finger 33 and the like on the recess and projection portions 25, the state where the middle finger 33 and the like are inserted into the finger placing holes 6a, 6b can be more reliably maintained. Therefore, the fingertips can be prevented from reaching the opposing inner surfaces 10a, 10b by a careless sliding movement of the middle finger 33 or the like, and the fingertips can be prevented from being pinched between the opposing inner surfaces 10a, 10b or between the protruding portions 21a and 21b. In this embodiment, as illustrated in FIGS. 4A and 4B, the recess and projection portions 25 are formed by arranging, along the front and rear directions, a plurality of recessed portions on the left side surface 17a including the first inclined surface 171a, the second inclined surface 172a, and the third inclined surface 173a, of the operation portion 7a and on the right side surface 17b including the first inclined surface 171b, the second inclined surface 172b, and the third inclined surface 173b, of the operation portion 7b.

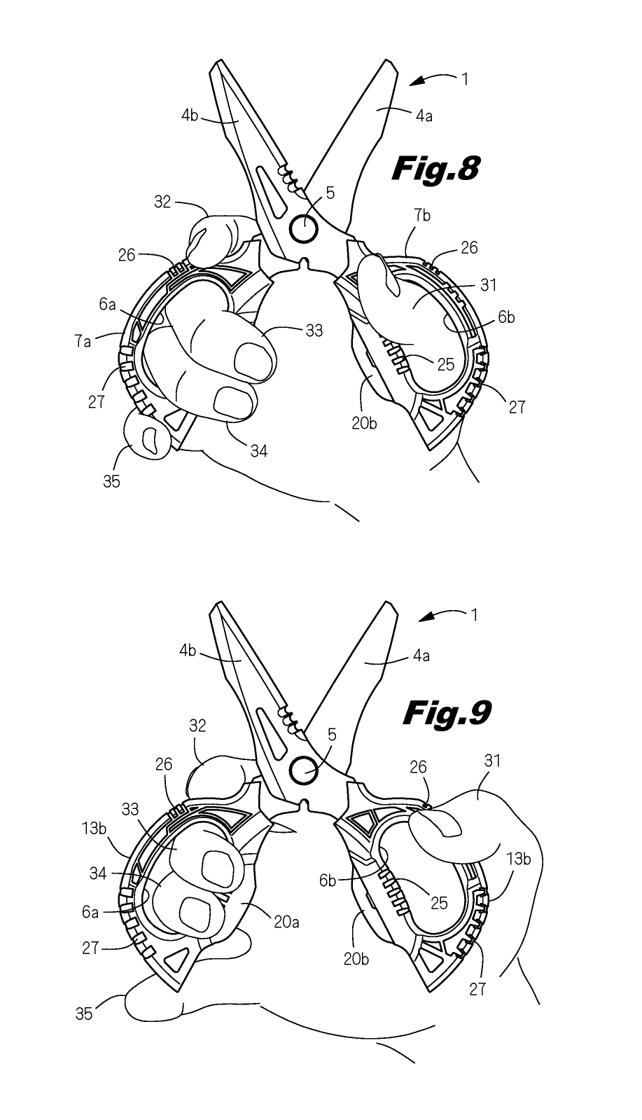

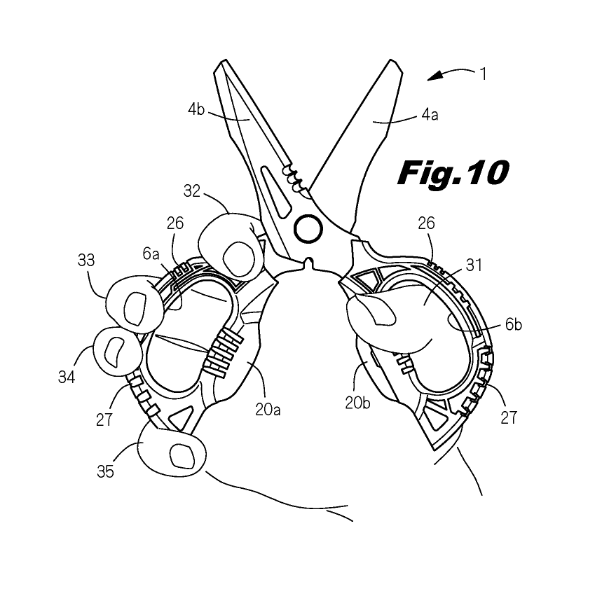

The scissors according to this embodiment can employ a use mode as illustrated in FIGS. 9 and 10 other than the use mode illustrated in FIG. 8. The use mode illustrated in FIG. 9 differs from the use mode illustrated in FIG. 8 in that, rather than inserting the thumb 31 into the right finger placing hole 6b, the thumb 31 is placed on the outer peripheral edge of the outer block 13b of the right operation portion 7b. In order to adapt to the above described use mode, in this embodiment, anti-slipping recess and projection portions 26 are formed on contact points with the thumb 31 at the front of the outer blocks 13a, 13b. In this way, when closing the operation portions 7a, 7b by placing the thumb 31 on the outer peripheral edge of the outer block 13b, the gap between the thumb 31 and the middle and third fingers 33 and 34 can be made larger as compared to the use mode illustrated in FIG. 8. Therefore, the closing operation (cutting operation) can be performed by applying larger force to the operation portions 7a, 7b. Further, since the anti-slipping recess and projection portions 26 are formed on the outer blocks 13a, 13b corresponding to the contact points with the thumb 31, it is possible to effectively prevent the thumb 31 from sliding carelessly even when such a use mode is employed.

The use mode illustrated in FIG. 10 differs from the use mode illustrated in FIG. 8 in that the thumb 31 is inserted into the finger placing hole 6b of the right operation portion 7b, and four fingers, from the index finger 32 to the little finger 35, are placed on the outer peripheral edge of the outer block 13a of the operation portion 7a. In order to adapt to the above described use mode, in this embodiment, anti-slipping recess and projection portions 27 are formed on contact points with the third finger 34 at the rear of the outer block 13a. In this way, even when closing operation is performed to the operation portions 7a, 7b with the four fingers, from the index finger 32 to the little finger 35, placed on the outer peripheral edge of the outer blocks 13a, 13b, the gap between the middle finger 33 and the third finger 34, and the thumb 31 can be made larger as compared to the use mode illustrated in FIG. 8, similar to the use mode illustrated in FIG. 9. Therefore, the closing operation (cutting operation) can be performed by applying larger force to the operation portions 7a, 7b. Further, since the anti-slipping recess and projection portions 27 are formed on the contact points with the third finger 34 and the like, the third finger 34 and the like can be effectively prevented from sliding carelessly even when the use mode is employed.

The shapes and the like of the operation portions 7a, 7b of the scissors according to the present invention are not limited to those shown in the above embodiment. For example, the recess and projection portions 26, 27 of the outer blocks 13a, 13b are not always necessary, as long as the finger pinch prevention guards 20a, 20b are formed on the operation portions 7a, 7b. In the above-described embodiment, the protruding portions 21a, 21b are formed on the opposing inner surfaces 10a, 10b of the both operation portions 7a, 7b. However, the present invention is not limited thereto, and the protruding portion 21a, 21b may be formed only on the opposing inner surface 10a, 10b of one operation portion 7a, 7b, and the opposing gap 23 may be formed by the tip end of one protruding portion 21a, 21b making contact with the opposing inner surface 10a, 10b.

### DESCRIPTION OF REFERENCE SIGNS

1: scissors
2: cutting portion
3: handle portion
4a, 4b: scissor piece
5: rotation center shaft
6a, 6b: finger placing hole
7a, 7b: operation portion
20a, 20b: finger pinch prevention guard
21a, 21b: protruding portion
23: opposing gap
25: recess and projection portion

1. Scissors comprising:
a pair of upper and lower scissor pieces having cutting portions at front ends thereof and handle portions at rear ends thereof;
a rotation center shaft provided in center portions in front and rear directions of the scissor pieces so as to crossingly and swingably support the scissor pieces with each other, the scissor pieces being assembled in an X-shape; and
a pair of left and right operation portions attached to the handle portions of the scissor pieces and having finger placing holes (6a, 6b) for placing fingertips of a user, wherein
with the fingertips placed on the finger placing holes, the cutting portions are opened and closed by opening and closing the both operation portions about the rotation center shaft between an open position in which opposing inner surfaces, of the both operation portions are apart from each other and a closed position in which the opposing inner surfaces of the both operation portions are close to each other,
finger pinch prevention guards are formed on an upper end of one operation portion on left or right and on a lower end of the other operation portion so as to extend in a cantilever manner to an inside in left and right directions from the upper end and the lower end, thereby preventing the fingertips from entering the opposing inner surfaces side from above or below by being overlapped with an upper end surface or a lower end surface of the operation portions opposed thereto when the both operation portions are in a closed position,
an opposing gap is formed between the finger pinch prevention guards and the upper end surface and the lower end surface of the operation portions opposed to the finger pinch prevention guards when the both operation portions are in the closed position, and
due to the opposing gap, the finger pinch prevention guards and the upper end surface and the lower end surface of the operation portions opposed to the finger pinch prevention guards do not make contact with each other when the both operation portions are in the closed position.

2. The scissors according to claim 1, wherein
the upper end surface and the lower end surface of the operation portions opposed to the finger pinch prevention guards in the closed position are flat surfaces.

3. The scissors according to claim 1, wherein
anti-slipping recess and projection portions are formed on base end portions of the operation portions of the finger pinch prevention guards.

4. The scissors according to claim 1, wherein
protruding portions for restricting a proximity limit of the both operation portions in the closed position are formed on one or both of the opposing inner surfaces of the both operation portions, an opposing gap being formed between the both operation portions in the closed position by the protruding portions making contact with each other or by tip ends of the protruding portions making contact with the opposing inner surfaces, and
the finger pinch prevention guards are capable of preventing the fingertips from entering the opposing gap from above and below when the both operation portions are in the closed position.

5. The scissors according to claim 2, wherein
protruding portions for restricting a proximity limit of the both operation portions in the closed position are formed on one or both of the opposing inner surfaces of the both operation portions, an opposing gap being formed between the both operation portions in the closed position by the protruding portions making contact with each other or by tip ends of the protruding portions making contact with the opposing inner surfaces, and
the finger pinch prevention guards are capable of preventing the fingertips from entering the opposing gap from above and below when the both operation portions are in the closed position.

6. The scissors according to claim 3, wherein
protruding portions for restricting a proximity limit of the both operation portions in the closed position are formed on one or both of the opposing inner surfaces of the both operation portions, an opposing gap being formed between the both operation portions in the closed position by the protruding portions making contact with each other or by tip ends of the protruding portions making contact with the opposing inner surfaces, and
the finger pinch prevention guards are capable of preventing the fingertips from entering the opposing gap from above and below when the both operation portions are in the closed position.
